(19) United States
(12) Patent Application Publication
(10) Pub. No.: US 2026/0030733 A1
(43) Pub. Date: Jan. 29, 2026

(54) SIAMESE TRANSFORMER NETWORK FOR PREDICTING IMAGE QUALITY OF IMAGES AND TRAINING THEREOF

(71) Applicant: Samsung Electronics Co., Ltd., Suwon-si (KR)

(72) Inventors: Arshita Gupta, Irvine, CA (US); Tien C. Bau, Irvine, CA (US)

(21) Appl. No.: 19/281,395

(22) Filed: Jul. 25, 2025

Related U.S. Application Data
(60) Provisional application No. 63/676,857, filed on Jul. 29, 2024.

(51) Int. Cl. G06T 7/00; G06N 3/045

(52) U.S. Cl. CPC G06T 7/0002; G06N 3/045

(57) ABSTRACT

A method includes obtaining, using at least one processing device of an electronic device, a specified image. The method also includes identifying, using the at least one processing device, a reference image and a corresponding reference image label. The method further includes inputting, using the at least one processing device, the specified image and the reference image to a Siamese transformer network trained to predict an image quality difference between an input image pair. The method also includes predicting, using the Siamese transformer network, an image quality difference between the specified image and the reference image. In addition, the method includes adding, using the at least one processing device, the corresponding reference image label to the predicted image quality difference to obtain an image quality score of the specified image.

### CROSS-REFERENCE TO RELATED APPLICATION AND PRIORITY CLAIM

This application claims priority under 35 U.S.C. § 119(e) to U.S. Provisional Patent Application No. 63/676,857 filed on Jul. 29, 2024, which is hereby incorporated by reference in its entirety.

### TECHNICAL FIELD

This disclosure relates generally to image processing systems and processes. More specifically, this disclosure relates to a Siamese transformer network for predicting image quality of images and training thereof.

### BACKGROUND

With the recent surge of improved image processing techniques and artificial intelligence (AI) generated images, there is a growing demand for intelligent systems that can accurately judge the authenticity and quality of images. However, as image data is present in abundance, manually labelling images can be expensive and time-consuming.

### SUMMARY

This disclosure relates to a Siamese transformer network for predicting image quality of images and training thereof.

In a first embodiment, a method includes obtaining, using at least one processing device of an electronic device, a specified image. The method also includes identifying, using the at least one processing device, a reference image and a corresponding reference image label. The method further includes inputting, using the at least one processing device, the specified image and the reference image to a Siamese transformer network trained to predict an image quality difference between an input image pair. The method also includes predicting, using the Siamese transformer network, an image quality difference between the specified image and the reference image. In addition, the method includes adding, using the at least one processing device, the corresponding reference image label to the predicted image quality difference to obtain an image quality score of the specified image.

In a second embodiment, an electronic device includes at least one processing device configured to obtain a specified image. The at least one processing device is also configured to identify a reference image and a corresponding reference image label. The at least one processing device is further configured to input the specified image and the reference image to a Siamese transformer network trained to predict an image quality difference between an input image pair. The at least one processing device is also configured to predict, using the Siamese transformer network, an image quality difference between the specified image and the reference image. In addition, the at least one processing device is configured to add the corresponding reference image label to the predicted image quality difference to obtain an image quality score of the specified image.

In a third embodiment, a non-transitory machine readable medium contains instructions that when executed cause at least one processor of an electronic device to obtain a specified image. The non-transitory machine readable medium also contains instructions that when executed cause the at least one processor to identify a reference image and a corresponding reference image label. The non-transitory machine readable medium further contains instructions that when executed cause the at least one processor to input the specified image and the reference image to a Siamese transformer network trained to predict an image quality difference between an input image pair. The non-transitory machine readable medium also contains instructions that when executed cause the at least one processor to predict, using the Siamese transformer network, an image quality difference between the specified image and the reference image. In addition, the non-transitory machine readable medium contains instructions that when executed cause the at least one processor to add the corresponding reference image label to the predicted image quality difference to obtain an image quality score of the specified image.

Any one or any combination of the following features may be used with the first, second, or third embodiment. The image quality score may be predicted by processing, using a first transformer of the Siamese transformer network, the specified image based on shared parameters; processing, using a second transformer of the Siamese transformer network, the reference image based on the shared parameters; concatenating, using the Siamese transformer network, image representations of the specified image and the reference image; and predicting, using the Siamese transformer network, an image quality difference between the specified image and the reference image based on the image representations. The image quality score may be predicted by dividing each of the specified and reference images into a plurality of patches; creating a sequence of patch embeddings for the patches of the specified and reference images; and combining a learnable class token with the sequence of patch embeddings. The class token may serve as a global image representation. The Siamese transformer network may be trained to predict an image quality difference between each pair of one or more pairs of input images. The Siamese transformer network may be trained by selecting pairs of labeled images from a labeled image dataset and predicting an image quality difference between the labeled images in each pair of labeled images. The Siamese transformer network may be trained by obtaining an unlabeled target image from an unlabeled image dataset; freezing parameters of the Siamese transformer network; generating multiple initial pseudo-labels for the unlabeled target image based on the labeled images from the labeled image dataset; ensembling the multiple initial pseudo-labels to generate a final pseudo-label; and unfreezing the parameters of the Siamese transformer network. The Siamese transformer network may be in a prediction mode when the initial pseudo-labels and the final pseudo-label are generated. The Siamese transformer network may be trained by associating the unlabeled target image with a labeled image from the labeled image dataset and predicting an image quality difference between the unlabeled target image and the associated labeled image using the final pseudo-label as a ground truth for the unlabeled target image. The Siamese transformer network may be trained by repeatedly obtaining unlabeled target images from the unlabeled dataset and generating corresponding final pseudo-labels. The unlabeled target image may include distortions different from distortions in the labeled images.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example architecture for a Siamese transformer network in accordance with this disclosure;

FIG. 3 illustrates an example pipeline for Siamese transformer assisted pseudo label ensembling (STAPLE) in accordance with this disclosure;

FIG. 4 illustrates an example pipeline for Siamese transformer network prediction mode (STN prediction mode) in accordance with this disclosure;

FIG. 5 illustrates an example pipeline for training a Siamese transformer network in accordance with this disclosure;

FIG. 6 illustrates an example method for training a Siamese transformer network to predict an image quality difference between an unlabeled image and a labeled image in accordance with this disclosure; and

FIG. 7 illustrates an example method for predicting an image quality difference between a specified image and a reference image using a Siamese transformer network in accordance with this disclosure.

### DETAILED DESCRIPTION

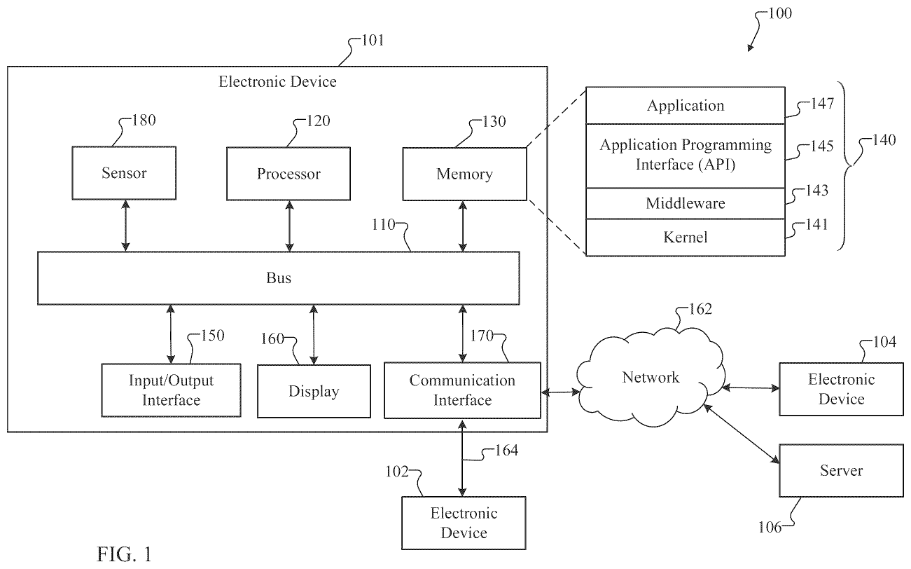

FIGS. 1 through 7, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, with the recent surge of improved image processing techniques and artificial intelligence (AI) generated images, there is a growing demand for intelligent systems that can accurately judge the authenticity and quality of images. However, as image data is present in abundance, manually labelling images can be expensive and time-consuming.

In some cases, an Image Quality Assessment (IQA) model can be built using classical computer vision and deep learning techniques. These IQA models can be trained using image datasets, which may contain actual captured images or images that are synthetically generated. The ground truths for these images often include either a “Mean Opinion Score” (MOS) or a “Difference of Mean Opinion Score” (DMOS) for each image. These scores can be created by crowd-sourcing the images and collecting scores, which may be averaged. A higher MOS (or lower DMOS) may correspond to a good quality image.

“No reference IQA” (NR-IQA) is a common image quality assessment technique in which there is no information about an original image for use during an assessment. NR-IQA models are widely used to assess perceptual quality in tasks such as image super-resolution. However, NR-IQA models may excel only when a target domain (D_{T}) closely resembles a labeled source domain (D_{S}), and the accuracy of NR-IQA models can drop sharply when these distributions differ. While fine-tuning on the domain D_{T} can mitigate this issue, it may require costly MOS label collection and may risk degrading source performance.

These challenges highlight the need for Unsupervised Domain Adaptation (UDA), which transfers knowledge from a labeled domain D_{S} to an unlabeled domain D_{T}. However, recent UDA techniques for IQA may be limited to either (i) using synthetic data as the domain D_{S} and “in-the-wild” images as the domain D_{T} or (ii) requiring time-consuming adversarial training. While distortion-guided unsupervised domain adaptation (DGQA) may achieve a high target performance, it does so by sacrificing source accuracy and requiring overlapping distortions between the domains D_{S} and D_{T}.

In some cases, NR-IQA may perform well when trained and tested on “in the wild” datasets but may struggle when tested on challenging simulated synthetic distortions and vice-versa. Often times, IQA models can be trained on “image-MOS” pairs, which may belong to a given data distribution, and can perform well when tested on “in-distribution” (ID) data. However, it has been observed that a large drop in performance can occur when these models are tested on “out-of-distribution” (OOD) datasets. For example, a model trained on an “in the wild” dataset (such as the KONIQ-10K dataset) may have largely-seen images with distortions including blur, contrast, and JPEG compression. However, this model's performance may be heavily affected when tested on a different type of distortion that does not exist in abundance in the training dataset.

This disclosure provides various techniques related to a Siamese transformer network for predicting image quality of images and training thereof. For example, as described in more detail below, a specified image can be obtained, and a reference image and a corresponding reference image label can be identified. The specified image and the reference image can be input to a Siamese transformer network that is trained to predict an image quality between an input image pair. The Siamese transformer network can be used to predict an image quality difference between the specified image and the reference image.

In some embodiments, a Siamese transformer network (STN) can include two identical networks (such as residual network-based feature extractors followed by transformer blocks) with shared parameters. Unlike other IQA models that predict absolute MOS, an STN may focus on pair-wise learning between images. For instance, pairs of images may be sent to each network of the STN, and output tokens from the networks may be concatenated and sent through a series of multi-layer perceptron (MLP) layers to learn differences in image quality between the images of each pair.

The disclosure also provides various techniques for Siamese transformer-assisted pseudo-label ensembling (STAPLE), which is a UDA technique for NR-IQA. STAPLE can leverage an STN and generate high-quality pseudo-labels by pairing unlabeled target images in a domain D_{T} with labeled source images in a domain D_{S}. That is, the STN may adapt to an unsupervised domain by associating an unlabeled image with labeled images and generating a highly-accurate pseudo-label to predict an image quality difference between an image pair and an image quality score of the unlabeled image. By ensembling predictions from multiple source references, the STN may robustly reduce variance and consistently maintain a high accuracy on both source and target domains for NR-IQA without requiring additional fine-tuning.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to training and/or using a Siamese transformer network to predict image quality scores for images.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications for, among other things, training and/or using a Siamese transformer network to predict an image quality difference between an input image pair. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to training and/or using a Siamese transformer network to predict image quality difference between an input image pair.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

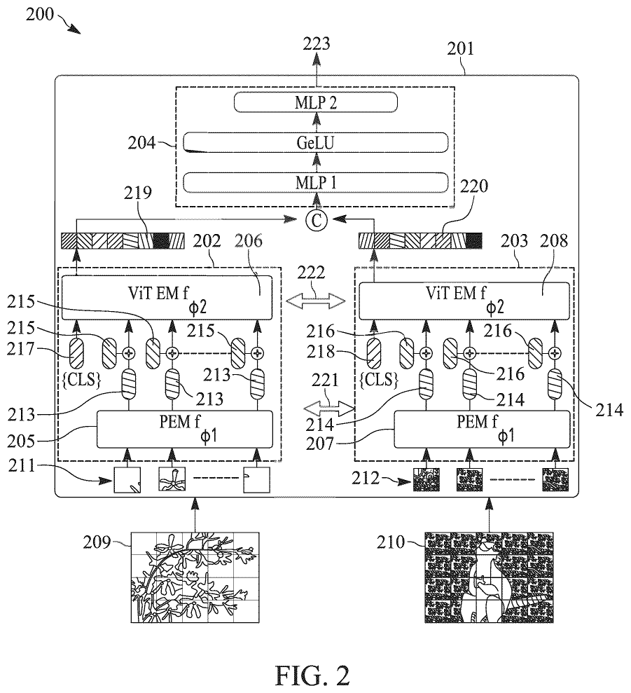

FIG. 2 illustrates an example architecture 200 for a Siamese transformer network 201 in accordance with this disclosure. For ease of explanation, the architecture 200 shown in FIG. 2 is described as being implemented using the electronic device 101 in the network configuration 100 shown in FIG. 1. However, the architecture 200 shown in FIG. 2 may be implemented using any other suitable device(s) (such as the server 106) and in any other suitable system(s).

As shown in FIG. 2, the Siamese transformer network 201 can include a first subnetwork 202, a second subnetwork 203, and a two-layer multi-layer perceptron (MLP) network 204. In this example, the first subnetwork 202 includes a first patch encoder f_{ϕ1} 205 and a first transformer f₂206, and the second subnetwork 203 includes a second patch encoder f_{ϕ1} 207 and a second transformer f_{ϕ2} 208. The first and second patch encoders 205, 207 may receive a first labeled image xᵢ 209 and a second labeled image xⱼ 210, respectively. Thus, each labeled image 209, 210 may serve as a separate input stream for parallel processing by the first and second subnetworks 202, 203.

The first and second labeled images 209, 210 can be divided into a plurality of patches 211, 212, where each patch 211, 212 represents a portion of the corresponding labeled image 209, 210. The patches 211, 212 may be generated in any suitable manner, and the patches 211, 212 for each labeled image 209, 210 may or may not overlap one another. The patches 211, 212 can be embedded into a feature space using respective patch encoders 205, 207 with function f_{ϕ1}. For example, the first and second patch encoders 205, 207 may transform the patches 211, 212 into a sequence of patch embeddings 213, 214 and append respective positional encodings 215, 216 and learnable class tokens (CLS) 217, 218. In some cases, the class tokens 217, 218 may be appended at the start of the sequence of patch embeddings 213, 214 to provide an understanding of the overall context of the respective labeled images 209, 210 and to act as a global representation of the entire image 209, 210. Since each class token 217, 218 is a learnable token, it may be updated after every transformer layer and serve as an image representation.

The first and second transformers 206, 208 may be vision transformer encoders and can process the transformed patch embeddings with function f_{ϕ2}. For example, the first transformer 206 may receive the transformed patch embeddings from the first patch encoder 205 and generate a feature image representation 219 of the first labeled image 209. Similarly, the second transformer 208 may receive the transformed patch embeddings from the second patch encoder 207 and generate a feature image representation 220 of the second labeled image 210. In some embodiments, each transformer 206, 208 may apply multi-head attention and/or one or more feed-forward networks to capture spatial relationships within the image patches 211, 212. The transformers 206, 208 may learn the representations 219, 220, which best describe the first and second labeled images 209, 210, based on the class tokens 217, 218. In some cases, the representations 219, 220 may be concatenated and passed through the two-layer MLP network 204 to predict an image quality difference between the two labeled images 209, 210.

While the first and second subnetworks 202, 203 may process respective labeled images 209, 210 separately, they may share parameters ϕ1 and ϕ2 (as shown by arrows 221, 222). That is, although there are two input paths to the Siamese transformer network 201, parameters ϕ1 and ϕ2 may be shared between these paths. In some cases, the only extra parameters that may be added could include those for the MLP network 204 (which may be very few). In other words, num(ϕ1)+num(ϕ2)˜num(θ). In this way, the performance of the Siamese transformer network 201 may significantly increase without increasing the total parameter count of the Siamese transformer network 201 to a significant extent.

Pair-wise learning by the Siamese transformer network 201 can differ significantly from other image quality assessment AI models. In general, an AI model f_{θ} (where θ is a learned parameter) may be fit to a labeled dataset such that f_{θ}(xᵢ)=y_{pred}. The parameter θ may be learned by minimizing a loss function L, such as in the following manner.

$$L = \vert {f}_{θ} ( {x}_{i} ) - {y}_{i} \vert \qquad EQ . 1$$

As illustrated in FIG. 2, the Siamese transformer network 201 may be trained by randomly selecting two image-MOS pairs {(xᵢ, yᵢ), (xⱼ, yⱼ)} from a labeled dataset. Thus, f_{θ} may take a first labeled image xᵢ 209 and a second labeled image x₁ 210 as input and predict an image quality difference 223, meaning f_{θ}(xᵢ, xⱼ)=y_{pred}. A modified loss function for the labeled dataset here may be expressed as follows.

$${L}_{Lb} = \vert {f}_{θ} ( {x}_{i} , {x}_{j} ) - ( {y}_{i} , {y}_{j} ) \vert \qquad EQ . 2$$

During inferencing, the Siamese transformer network 201 may predict an image quality score for the second labeled image xⱼ 210, such as in the following manner.

$${y}_{jpred} = {f}_{θ} ( {x}_{i} , {x}_{ref} ) + {y}_{ref} \qquad EQ . 3$$

As such, a reference image x_{ref} whose IQA is known may be selected, and (xⱼ,yⱼ) may be substituted with (x_{ref}, y_{ref}) to predict the image quality score (IQA score) (xⱼ, yⱼ) for a query image during inferencing.

Thus, by providing the Siamese transformer network 201 with random pairs of images in multiple training iterations, the Siamese transformer network 201 can effectively learn differences in image qualities. Further, the pair-wise learning may expand the effective training set from N to N² pairs (N being the size of the training dataset), thereby enabling the Siamese transformer network 201 to capture subtle image quality differences and achieving notable improvements in evaluation metrics such as the Pearson Linear Correlation Coefficient (PLCC) and/or the Spearman Rank Order Correlation Coefficient (SROCC). In addition, by learning the differences in the image qualities between paired images instead of single image-MOS pairs, the Siamese transformer network 201 may be able to learn a ranking between images based on the image qualities.

Although FIG. 2 illustrates one example of an architecture 200 for a Siamese transformer network 201, various changes may be made to FIG. 2. For example, various components or functions in FIG. 2 may be combined, further subdivided, replicated, omitted, or rearranged and additional components or functions may be added according to particular needs. As a particular example, the Siamese transformer network 201 may be adjusted to perform no reference image quality assessment, such as when the Siamese transformer network 201 receives a pair of labeled and unlabeled images and generate a pseudo-label for predicting the image quality of the unlabeled image.

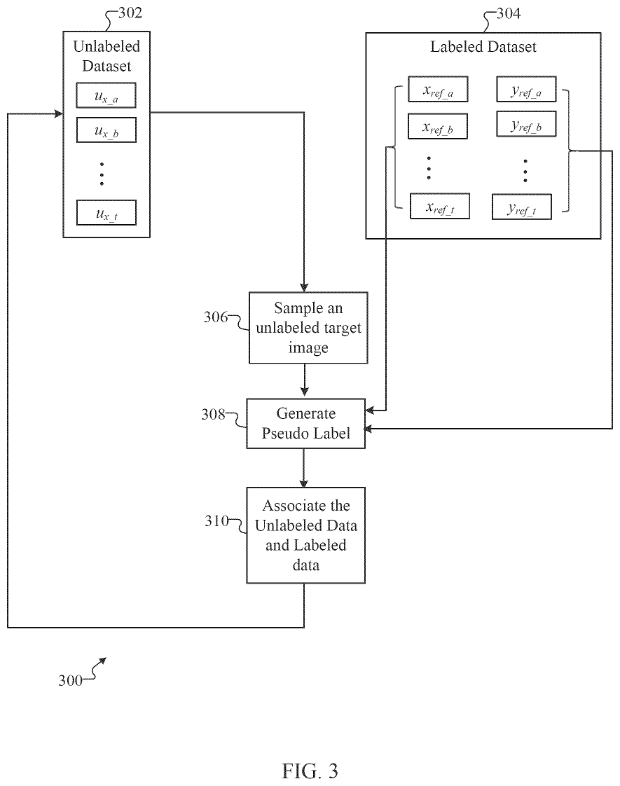

FIG. 3 illustrates an example pipeline 300 for Siamese transformer assisted pseudo label ensembling (STAPLE) in accordance with this disclosure. For ease of explanation, the pipeline 300 shown in FIG. 3 is described as being implemented using the electronic device 101 in the network configuration 100 shown in FIG. 1. However, the pipeline 300 shown in FIG. 3 may be implemented using any other suitable device(s) (such as the server 106) and in any other suitable system(s).

In some embodiments, STAPLE can be performed using the Siamese transformer network 201 of FIG. 2. However, the Siamese transformer network can be adapted to predict an image quality difference between an unlabeled image uₓ and labeled images x_{ref_t}. That is, pair-wise learning of differences in image qualities may allow the Siamese transformer network to effectively extrapolate on one or more out-of-distribution datasets (unlabeled datasets).

As shown in FIG. 3, the pipeline 300 includes a data sample operation 306, a pseudo-label generation operation 308, and an association operation 310. The data sample operation 306 generally operates to sample an unlabeled image uₓ and labeled images x_{ref_t}. This may include the processor 120 sampling a random unlabeled image u_{x_a} from an unlabeled dataset U 302 (including a total number M of unlabeled images) and labeled images x_{ref_a}-x_{ref_t} from a labeled dataset L 304 (including a total number N of the labeled images), where t is the number of labeled images randomly selected from the labeled dataset L 304. These t images may be paired with one unlabeled image randomly selected from the unlabeled dataset U 302. This may give t pairs ((x_{ref_a}, u_{x_a}), (x_{ref_b}, u_{x_a}) . . . (x_{ref_t} u_{x_a})). These t pairs may be individually sent to the pipeline 300 including a Siamese Transformer Network (STN) to predict t pseudo-labels. These t pseudo labels may be averaged to get one robust pseudo-label for u_{x_a}. The unlabeled dataset U 302 may contain different distortion than in the labeled dataset L 304. The distortions may include, for instance and without limitation, Gaussian noise, pixelation, and impulse noise types.

The pseudo-label generation operation 308 generally operates to generate a pseudo-label to be used as a ground truth for the unlabeled target image u_{x_a} when predicting the image quality difference between the unlabeled target image u_{x_a} and an associated labeled image x_{ref_t}. This may include the processor 120 using the Siamese transformer network to generate initial pseudo-labels for the unlabeled target image u_{x_a}. This may also include the Siamese transformer network 301 freezing the model weights, which could be expressed as follows.

$${y}_{{pred}_{q}} = {f}_{θ}^{′} ( {x}_{q} , {x}_{ref} ) + {y}_{ref} \qquad EQ . 4$$

Here, f_{θ}′ indicates that the Siamese transformer network's parameters are frozen at this pseudo-label generation stage. Also, x_{ref} and y_{ref} belong to the labeled dataset L 304, x_{q} is a query image (such as the unlabeled image u_{x_a}), and y_{pred}_{_{q}} is an image quality (such as an image quality score) predicted for the query image.

As shown in EQ. 4, to predict the image quality score y_{pred}_{_{q}} of a random unlabeled image u_{x_a}, the Siamese transformer network may use a reference image x_{ref} with a known ground truth y_{ref}. The Siamese transformer network can predict the image quality difference between the query image x_{q} and the reference image x_{ref}. The processor 120 can add the predicted image quality difference to the ground truth y_{ref} and output an image quality score y_{pred}_{_{q}}.

Since EQ. 4 illustrates using a single reference image to predict the pseudo-label for the unlabeled image u_{x_a}, this can lead to noisy pseudo-labels and include a high predictor variance depending on the associated labeled image x_{ref}. To help overcome this issue, in some embodiments, the Siamese transformer network may run multiple times by pairing the unlabeled image u_{x_a}, with different labeled data (x_{ref_a}, x_{ref}_{_{b}}, . . . , x_{ref_t}) to obtain a robust pseudo-label. That is, multiple pseudo-labels are generated based on the pairing and ensembled (averaged) to obtain the final pseudo-label for the unlabeled target image u_{x_a}.

Note that the Siamese transformer network may freeze the model weights during the generation of the pseudo-labels as shown with EQ. 4 above and unfreeze the model weights after the generation of the pseudo-labels. The pseudo-labels before ensembling may be referred to here as initial pseudo-labels, and the average or other calculated pseudo-label may be referred to here as a final pseudo-label. Also note that the Siamese transformer network 301 may be in the prediction mode when the pseudo-labels are generated.

In some cases, the initial pseudo-labels may be ensembled by utilizing the Siamese transformer network with multiple labeled images (image-label (x_{ref_t}, y_{ref_t}) pairs) and making multiple pseudo-label predictions for the unlabeled target image u_{x_a}. For example, T reference images x_{ref,t} from the labeled dataset L 304 may be sampled, and t different pseudo-labels up_{i,t} for the unlabeled target image uxᵢ (such as u_{x_a}) may be generated. The ensembled up_{i,t} may be averaged or otherwise processed to obtain a high-quality pseudo-label u\tilde{p}ᵢ, such as in the following manner.

$$u {\tilde{p}}_{i} = \frac{1}{T} {\sum }_{t = 1}^{T} ( upi , t ) \qquad EQ . 5$$

$$Here :$$

$${up}_{i , t} = {f}_{θ}^{′} ( {ux}_{i} , {x}_{ref , t} ) + {y}_{ref , t} \qquad EQ . 6$$

The association operation 310 generally operates to associate unlabeled data and labeled data. This may include the processor 120 associating the unlabeled target image u_{x_a} with the generated pseudo label and the labeled images (such as the reference images x_{ref}) with corresponding labels (such as the ground truth y_{ref}). This may also include the processor 120 unfreezing the parameters of the Siamese transformer network and training the Siamese transformer network with the unfrozen parameters. For example, the processor 120 may select pairs of labeled images from the labeled dataset L 304 to perform supervised training of the Siamese transformer network. This may also include the processor 120 associating (pairing) the unlabeled target image u_{x_a} (with a pseudo-label generated in the operation 308) with a labeled image from the labeled dataset L 304 to perform unsupervised training of the Siamese transformer network.

During training, the Siamese transformer network 301 may learn to predict an image quality difference between the unlabeled target image u_{x_a} and the associated unpaired labeled image (such as xₖ), such as by using the final pseudo-label [symbol] (denoted here as [symbol] ) as the ground truth for the unlabeled target image u_{x_a}.

In some embodiments, the loss function for the unlabeled dataset U 302 may be expressed in the following manner.

$${L}_{U Lb} = \vert {f}_{θ} ( {ux}_{i} , {x}_{k} ) - ( - {y}_{k} ) \vert \qquad EQ . 7$$

Here, (xₖ, yₖ) are image-MOS pairs from the labeled dataset L 304. For the overall process 300, the Siamese transformer network 301 may be trained on the labeled dataset L 304 and the unlabeled dataset U 302 by combining EQ. 2 and EQ. 7, such as in the following manner.

$$L = {L}_{Lb} + λ {L}_{U Lb} = \vert {f}_{θ} ( {x}_{i} , {x}_{j} ) ( {y}_{i} , {y}_{j} ) \vert + λ \vert {f}_{θ} ( {ux}_{i} , {x}_{k} ) - ( - {y}_{k} ) \vert \qquad EQ . 8$$

Here, λ is a weighting hyper-parameter for an unsupervised domain U (the unlabeled dataset U 302). The value of λ can impact test accuracy for both the labeled dataset L 304 and the unlabeled dataset U 302 during training. For example, when λ=λ₁ (fixed at 0.1), learning on the unlabeled dataset may be limited, and this value may be insufficient for effective learning. When λ=λ₃ (increases from 0.1 to 0.2 at about the 10^{th} training epoch and from 0.2 to 0.3 at about the 20^{th} training epoch and remains at 0.3) and λ=λ₄ (increases from 0.1 to 0.5 at about every 10^{th} training epoch), the Siamese transformer network 301 may exhibit steady accuracy growth but eventually collapse as λ becomes too dominant, causing a drop in the accuracy. In some cases, the accuracy may be optimal when λ=λ₂ (increases from 0.1 to 0.2 at about the 10^{th} training epoch and from 0.2 to 0.3 at about the 20^{th} training epoch and drops by 0.1 at about 30^{th} and 40^{th} training epoch to 0.1). Since A is a hyper-parameter, any value of λ can be used to help stabilize the training of the Siamese transformer network 301 and achieve a high accuracy.

As shown in EQ. 8, the Siamese transformer network 301 may utilize two sets of image pairs with EQ. 2 (the first term L_{Lb} indicating a pair of two labeled images and the second term) and EQ. 7 (the term L_{U Lb} indicating pairs of images from the labeled and unlabeled datasets). EQS. 2 and 7 may be combined using λ. The term L_{U Lb} may help the Siamese transformer network 301 to adapt to new distortions, while the term L_{Lb} may help to prevent collapse of the Siamese transformer network 301.

Upon predicting the image quality differences between the unlabeled target image u_{x_a} and the reference images x_{ref}, a next random unlabeled target image u_{x_b} may be obtained from the unlabeled dataset U 302, and a corresponding final pseudo-label [symbol] may be generated. This can be repeated until a last corresponding final pseudo-label [symbol] and a last image quality difference for a last unlabeled target image u_{x_t} from the unlabeled dataset U 302 is obtained. By ensembling the initial pseudo-labels, the Siamese transformer network 301 can generate a high-quality final pseudo-label [symbol] for an unlabeled target image u_{x_i}, thereby reducing predictor variances to predict the image quality differences between unlabeled-labeled image pairs with higher accuracy (compared to other AI IQA models).

Although FIG. 3 illustrates one example of a pipeline 300 for STAPLE, various changes may be made to FIG. 3. For example, various components or functions in FIG. 3 may be combined, further subdivided, replicated, omitted, or rearranged and additional components or functions may be added according to particular needs.

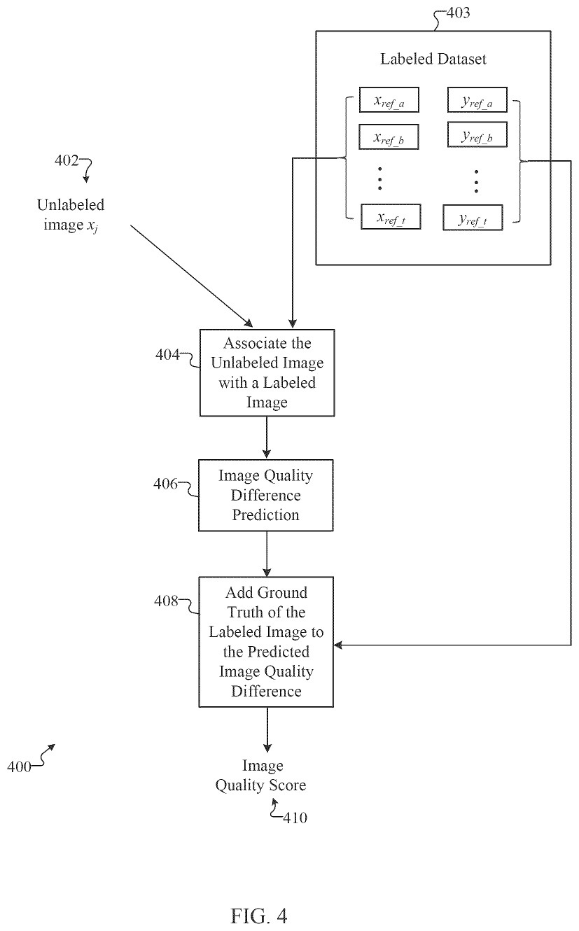

FIG. 4 illustrates an example pipeline 400 for Siamese transformer network prediction mode (STN prediction mode) in accordance with this disclosure. For ease of explanation, the example pipeline 400 shown in FIG. 4 is described as being implemented using the electronic device 101 in the network configuration 100 shown in FIG. 1. However, the pipeline 400 shown in FIG. 4 may be implemented using any other suitable device(s) (such as the server 106) and in any other suitable system(s).

In some embodiments, the pipeline 400 may be performed as part of the pipeline 300 of FIG. 3. As shown in FIG. 4, an image quality score 410 of a specified unlabeled image xⱼ 402 using an associated labeled image xᵢ from a labeled dataset 403 can be obtained in the STN prediction mode. The specified unlabeled image xⱼ 402 may come from an unlabeled dataset, such as the unlabeled dataset U 302 of FIG. 3. The labeled dataset 403 may represent the labeled dataset L 304 of FIG. 3.

As shown in FIG. 4, the pipeline 400 includes an images association operation 404, an image quality difference prediction operation 406, and an addition association 408. The image association operation 404 generally operates to associate the specified unlabeled image xⱼ with a random labeled image xᵢ (such as x_{ref}).

The image quality difference prediction operation 406 generally operates to predict an image quality difference between the specified unlabeled image xⱼ 402 and the associated labeled image xᵢ. This may include the Siamese transformer network 401 predicting an image quality difference between the specified unlabeled image xⱼ 402 and the associated labeled image xᵢ.

The addition operation 408 generally operates to add the ground truth of the associated labeled image xᵢ (here, x_{ref_a}, x_{ref_b}, . . . , x_{ref_t}) to obtain the image quality score 410. This may include the processor 120 adding the corresponding ground truth y_{ref_a}, y_{ref_b}, . . . , y_{ref_t} of the respective associated labeled image x_{ref_a}, x_{ref_b}, . . . , x_{ref_t} to the predicted image quality difference to generate the image quality score 410 of the specified unlabeled xⱼ 402.

Although FIG. 4 illustrates one example of a pipeline 400 for the STN prediction mode 401, various changes may be made to FIG. 4. For example, various components or functions in FIG. 4 may be combined, further subdivided, replicated, omitted, or rearranged and additional components or functions may be added according to particular needs.

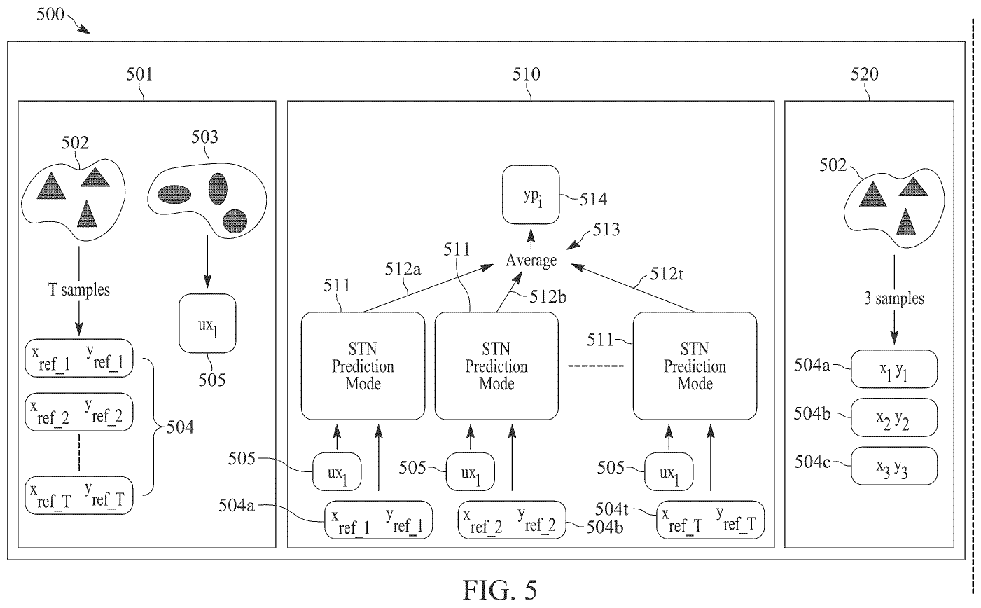

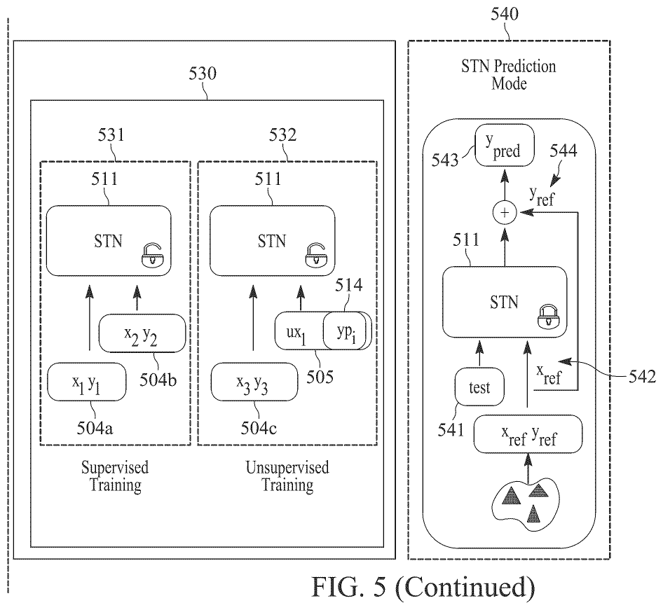

FIG. 5 illustrates an example pipeline 500 for training a Siamese transformer network 511 in accordance with this disclosure. For ease of explanation, the pipeline 500 shown in FIG. 5 is described as being implemented using the electronic device 101 in the network configuration 100 shown in FIG. 1. However, the pipeline 500 shown in FIG. 5 may be implemented using any other suitable device(s) (such as the server 106) and in any other suitable system(s).

As shown in FIG. 5, the pipeline 500 includes a data sampling operation 501, a pseudo-label generation operation 510, a labeled image sampling operation 520, and a dual training operation 530. The data sampling operation 501 generally operates to sample labeled images from a labeled dataset 502 and an unlabeled image from an unlabeled dataset 503. This may include the processor 120 sampling T reference images x_{ref,t} 504 from the labeled dataset 502 and sampling a random unlabeled image ux₁ 505 from the unlabeled dataset 503. This may also include the processor 120 associating the unlabeled image ux₁ 505 with the labeled reference images x_{ref,t}504ₜ and inputting the associated unlabeled-labeled image pairs sequentially to the Siamese transformer network 511. The labeled dataset 502 may represent the labeled dataset L 304 of FIG. 3 and/or the labeled dataset 403 of FIG. 4. The unlabeled dataset 503 may represent the unlabeled dataset U 302 of FIG. 3.

The pseudo-label generation operation 510 generally operates to generate a final pseudo-label 514 for the unlabeled image ux₁ 505. This may include the processor 120 using the Siamese transformer network 511 to generate initial pseudo-labels 512ₐ-512ₜ sequentially using the labeled reference images x_{ref,t}. This may also include the processor 120 using the Siamese transformer network 511 to average 513 the initial pseudo-labels 512ₐ-512ₜ to generate a final pseudo-label yₚᵢ 514.

The labeled image sampling operation 520 generally operates to sample labeled images for training the Siamese transformer network 511. This may include the processor 120 using the Siamese transformer network 511 to randomly select a number of the labeled images 504a-504c, selecting one or more pairs of the labeled data (such as labeled data 504a and 504b) randomly, and associating the unlabeled image 505 with an unpaired labeled data (such as labeled data 504c).

The dual training operation 530 generally operates to perform supervised and unsupervised training of the Siamese transformer network 511. This may include the processor 120 performing supervised training 531 on the Siamese transformer network 511 using the labeled image pairs 504a, 504b. This may also include the processor 120 performing unsupervised training 532 on the Siamese transformer network 511 using the unlabeled-labeled image pair. Note that the Siamese transformer network parameters may be unfrozen (meaning they can be updated, as illustrated by the open locks) during the supervised and/or unsupervised training.

In a prediction mode 540, the Siamese transformer network 511 may predict image quality difference between test images (labeled or unlabeled) 541 and labeled images 542. For example, the Siamese transformer network 511 may output an image quality score 543 of each test image 541 by adding predicted image quality differences and the ground truth 544 of the labeled image 542. Note that during the prediction mode, the Siamese transformer network parameters may be frozen (meaning its parameters cannot be updated, as illustrated by the closed lock).

Although FIG. 5 illustrates one example of a pipeline 500 for training a Siamese transformer network 511, various changes may be made to FIG. 5. For example, various components or functions in FIG. 5 may be combined, further subdivided, replicated, omitted, or rearranged and additional components or functions may be added according to particular needs.

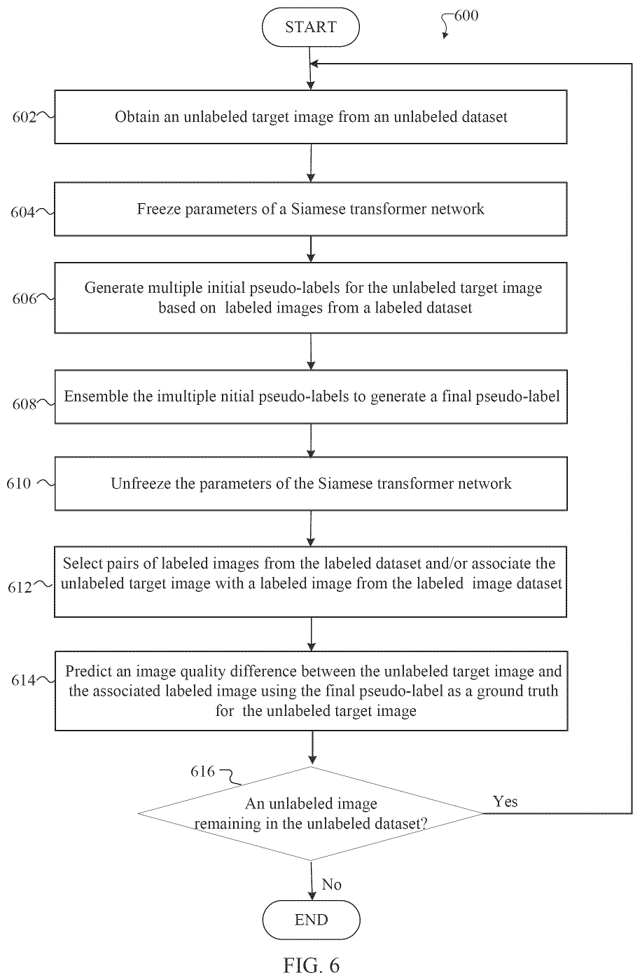

FIG. 6 illustrates an example method 600 for training a Siamese transformer network to predict an image quality difference between an unlabeled image and a labeled image in accordance with this disclosure. For ease of explanation, the method 600 shown in FIG. 6 is described as being performed using the electronic device 101 in the network configuration 100 shown in FIG. 1, where the electronic device 101 may implement the process 300 and pipeline 500 shown in FIGS. 3 and 5. However, the method 600 may be performed using any other suitable device(s) (such as the server 106) and in any other suitable system(s), and the method 600 may be implemented using any other suitable process(es) or architecture(s) designed in accordance with this disclosure.

As shown in FIG. 6, at step 602, an unlabeled target image may be obtained from an unlabeled dataset. This may include, for example, the processor 120 of the electronic device 101 sampling an unlabeled target image from an unlabeled target dataset and feeding the unlabeled target image to a Siamese transformer network. At step 604, parameters of the Siamese transformer network may be frozen. This may include, for example, the processor 120 of the electronic device 101 freezing the model weights of the Siamese transformer network and applying EQ. 4 to generate a pseudo-label for the unlabeled target image. Thus, the model's weights may not be updated during the generation of pseudo-labels.

At step 606, the Siamese transformer network may generate multiple initial pseudo-labels for the unlabeled target image based on labeled images from the labeled image dataset. This may include, for example, the processor 120 of the electronic device 101 using the Siamese transformer network 301 to process multiple labeled images and make multiple pseudo-label predictions for the unlabeled target image. For example, where a number of sampled labeled images is t, t reference images x_{ref,t} from the labeled image dataset may be sampled, and t different pseudo-labels (initial pseudo-labels) for the unlabeled target image may be generated. At step 608, the Siamese transformer network may average or otherwise process the initial pseudo-labels to generate a final pseudo-label. This may include, for example, the processor 120 of the electronic device 101 using the Siamese transformer network 301 to ensemble the initial pseudo-labels to obtain a high-quality final pseudo-label. At step 610, the parameters of the Siamese transformer network may be unfrozen. This may include, for example, the processor 120 of the electronic device 101 unfreezing the model weights of the Siamese transformer network 301 after the generation of the pseudo-labels. At this point, the model's weights may be updated.

At step 612, pairs of labeled images from the labeled dataset may be selected, and the unlabeled target image may be associated with an unpaired labeled image from the labeled image dataset. This may include, for example, the processor 120 of the electronic device 101 pairing random labeled images from the labeled dataset for supervised training. This may also include the processor 120 associating the unlabeled target image with a labeled image from the labeled dataset for unsupervised training. At step 614, an image quality difference between the unlabeled target image and the associated labeled image of each pair may be predicted. This may include, for example, the processor 120 of the electronic device 101 using the Siamese transformer network 301 to predict the image quality difference using the final pseudo-label as a ground truth for the unlabeled target image. This may also include the processor 120 of the electronic device 101 predicting an image quality score of the unlabeled target image based on the predicted image quality difference and the pseudo-label. At step 616, it may be determined whether an unlabeled image remains in the unlabeled dataset. This may include, for example, the processor 120 of the electronic device 101 determining if one or more unlabeled images remain in the unlabeled dataset. If the processor 120 determines that one or more unlabeled image remain in the unlabeled dataset, the method 600 returns to step 602 to sample a next unlabeled image and repeats steps 604-614. If the processor 120 determines that no unlabeled image remains in the unlabeled dataset, the method 600 ends.

Although FIG. 6 illustrates one example of a method 600 for training a Siamese transformer network to predict an image quality difference between an unlabeled image and a labeled image, various changes may be made to FIG. 6. For example, while shown as a series of steps, various steps in FIG. 6 may overlap, occur in parallel, occur in a different order, or occur any number of times (including zero times).

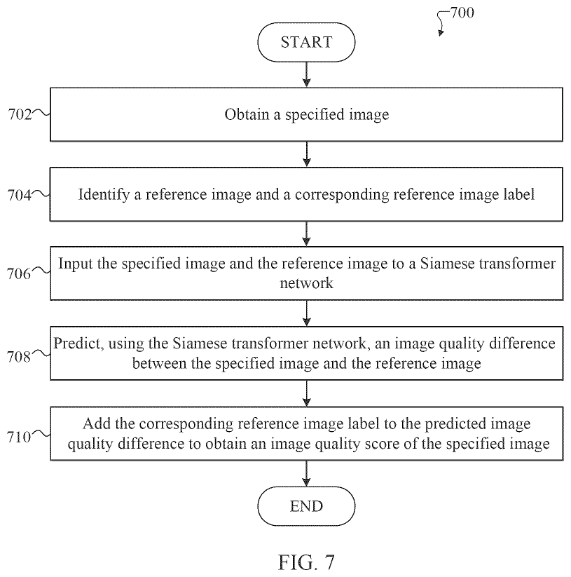

FIG. 7 illustrates an example method 700 for predicting an image quality difference between a specified image and a reference image using a Siamese transformer network in accordance with this disclosure. For ease of explanation, the method 700 shown in FIG. 7 is described as being performed using the electronic device 101 in the network configuration 100 shown in FIG. 1, where the electronic device 101 may implement the process 400 shown in FIG. 4. However, the method 700 may be performed using any other suitable device(s) (such as the server 106) and in any other suitable system(s), and the method 700 may be implemented using any other suitable process(es) or architecture(s) designed in accordance with this disclosure.

As shown in FIG. 7, at step 702, a specified image may be obtained. This may include, for example, the processor 120 of the electronic device 101 obtaining a specified image, such as by using one or more imaging sensors 180 of the electronic device 101. At step 704, a reference image and a corresponding reference image label may be identified. This may include, for example, the processor 120 of the electronic device 101 identifying the reference image and the corresponding reference image label from a memory 130 of the electronic device 101.

At step 706, the specified image and the reference image may be input to a Siamese transformer network. This may include, for example, the processor 120 of the electronic device 101 inputting the specified image and the reference image to the Siamese transformer network 401. The Siamese transformer network 401 may be trained to predict an image quality difference between an input image pair.

In some embodiments, the Siamese transformer network 401 may be trained by selecting pairs of labeled images from a labeled image dataset and predicting an image quality difference between the labeled images in each pair of labeled images. The Siamese transformer network 401 may also be trained by obtaining an unlabeled target image from an unlabeled image dataset, freezing parameters of the Siamese transformer network 401, generating multiple initial pseudo-labels for the unlabeled target image based on the labeled images from the labeled image dataset, averaging or otherwise using the multiple initial pseudo-labels to generate a final pseudo-label, and unfreezing the parameters of the Siamese transformer network 401. In some cases, the Siamese transformer network 401 may be in a prediction mode when the multiple initial pseudo-labels and the final pseudo-label are generated. The Siamese transformer network 401 may further be trained by associating the unlabeled target image with a labeled image from the labeled image dataset and predicting an image quality difference between the unlabeled target image and the associated labeled image using the final pseudo-label as a ground truth for the unlabeled target image. In addition, the Siamese transformer network may be trained by repeatedly obtaining unlabeled target images from the unlabeled dataset and generating corresponding final pseudo-labels. In particular embodiments, the unlabeled target image may include distortions different from distortions in the labeled images.

At step 708, the image quality difference between the specified image and the reference image may be predicted. This may include, for example, a first transformer of the Siamese transformer network 401 processing the specified image based on shared parameters. This may also include a second transformer of the Siamese transformer network 401 processing the reference image based on the shared parameters. This may further include the Siamese transformer network 401 concatenating image representations of the specified image and the reference image and predicting the image quality difference between the specified image and the reference image based on the image representations. In addition, this may include the Siamese transformer network 401 dividing each of the specified and reference images into a plurality of patches, creating a sequence of patch embeddings for the patches of the specified and reference images, and combining a learnable class token with the sequence of patch embeddings. The class token may serve as a global image representation.

At step 710, the corresponding reference image label is added to the predicted image quality difference. This may include the processor 120 adding back the corresponding reference image label to the predicted image quality difference to obtain an image quality score of the specified image.

Although FIG. 7 illustrates one example of a method 700 for predicting an image quality difference between a specified image and a reference image using a Siamese transformer network, various changes may be made to FIG. 7. For example, while shown as a series of steps, various steps in FIG. 7 may overlap, occur in parallel, occur in a different order, or occur any number of times (including zero times).

It should be noted that the functions shown in or described with respect to FIGS. 2 through 7 can be implemented in an electronic device 101, 102, 104, server 106, or other device(s) in any suitable manner. For example, in some embodiments, at least some of the functions shown in or described with respect to FIGS. 2 through 7 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 7 can be implemented or supported using dedicated hardware components. In general, the functions shown in or described with respect to FIGS. 2 through 7 can be performed using any suitable hardware or any suitable combination of hardware and software/firmware instructions. Also, the functions shown in or described with respect to FIGS. 2 through 7 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, a specified image;
identifying, using the at least one processing device, a reference image and a corresponding reference image label;
inputting, using the at least one processing device, the specified image and the reference image to a Siamese transformer network trained to predict an image quality difference between an input image pair;
predicting, using the Siamese transformer network, an image quality difference between the specified image and the reference image; and
adding, using the at least one processing device, the corresponding reference image label to the predicted image quality difference to obtain an image quality score of the specified image.

2. The method of claim 1, wherein predicting the image quality difference comprises:
processing, using a first transformer of the Siamese transformer network, the specified image based on shared parameters;
processing, using a second transformer of the Siamese transformer network, the reference image based on the shared parameters;
concatenating, using the Siamese transformer network, image representations of the specified image and the reference image; and
predicting, using the Siamese transformer network, the image quality difference between the specified image and the reference image based on the image representations.

3. The method of claim 2, further comprising:
dividing each of the specified and reference images into a plurality of patches;
creating a sequence of patch embeddings for the patches of the specified and reference images; and
combining a learnable class token with the sequence of the patch embeddings, wherein the class token serves as a global image representation.

4. The method of claim 1, wherein the Siamese transformer network is trained by:
selecting pairs of labeled images from a labeled image dataset; and
predicting an image quality difference between the labeled images in each pair of labeled images.

5. The method of claim 4, further comprising:
obtaining an unlabeled target image from an unlabeled image dataset;
freezing parameters of the Siamese transformer network;
generating multiple initial pseudo-labels for the unlabeled target image based on the labeled images from the labeled image dataset;
ensembling the multiple initial pseudo-labels to generate a final pseudo-label; and
unfreezing the parameters of the Siamese transformer network;
wherein the Siamese transformer network is in a prediction mode when the multiple initial pseudo-labels and the final pseudo-label are generated.

6. The method of claim 5, further comprising:
associating the unlabeled target image with a labeled image from the labeled image dataset; and
predicting an image quality difference between the unlabeled target image and the associated labeled image using the final pseudo-label as a ground truth for the unlabeled target image.

7. The method of claim 6, further comprising:
repeatedly obtaining unlabeled target images from the unlabeled dataset and generating corresponding final pseudo-labels.

8. The method of claim 5, wherein the unlabeled target image includes distortions different from distortions in the labeled images.

9. An electronic device comprising:
at least one processing device configured to:
obtain a specified image;
identify a reference image and a corresponding reference image label;
input the specified image and the reference image to a Siamese transformer network trained to predict an image quality difference between an input image pair;
predict, using the Siamese transformer network, an image quality difference between the specified image and the reference image; and
add the corresponding reference image label to the predicted image quality difference to obtain an image quality score of the specified image.

10. The electronic device of claim 9, wherein, to predict the image quality difference, the at least one processing device is configured to:
process, using a first transformer of the Siamese transformer network, the specified image based on shared parameters;
process, using a second transformer of the Siamese transformer network, the reference image based on the shared parameters;
concatenate image representations of the specified image and the reference image; and
predict the image quality difference between the specified image and the reference image based on the image representations.

11. The electronic device of claim 10, wherein the at least one processing device is further configured to:
divide each of the specified and reference images into a plurality of patches;
create a sequence of patch embeddings for the patches of the specified and reference images; and
combine a learnable class token with the sequence of patch embeddings, wherein the class token serves as a global image representation.

12. The electronic device of claim 9, wherein the Siamese transformer network is trained by:
selecting pairs of labeled images from a labeled image dataset; and
predicting an image quality difference between the labeled images in each pair of labeled images.

13. The electronic device of claim 12, wherein the Siamese transformer network is trained further by:
obtaining an unlabeled target image from an unlabeled image dataset;
freezing parameters of the Siamese transformer network;
generating multiple initial pseudo-labels for the unlabeled target image based on the labeled images from the labeled image dataset;
ensembling the multiple initial pseudo-labels to generate a final pseudo-label; and
unfreezing the parameters of the Siamese transformer network;
wherein the Siamese transformer network is in a prediction mode when the multiple initial pseudo-labels and the final pseudo-label are generated.

14. The electronic device of claim 13, wherein the Siamese transformer network is trained further by:
associating the unlabeled target image with a labeled image from the labeled image dataset; and
predicting an image quality difference between the unlabeled target image and the associated labeled image using the final pseudo-label as a ground truth for the unlabeled target image.

15. The electronic device of claim 14, wherein the Siamese transformer network is trained further by:
repeatedly obtaining unlabeled target images from the unlabeled dataset and generating corresponding final pseudo-labels.

16. A non-transitory machine readable medium containing instructions that when executed cause at least one processor of an electronic device to:
obtain a specified image;
identify a reference image and a corresponding reference image label;
input the specified image and the reference image to a Siamese transformer network trained to predict an image quality difference between an input image pair;
predict, using the Siamese transformer network, an image quality difference between the specified image and the reference image; and
add the corresponding reference image label to the predicted image quality difference to obtain an image quality score of the specified image.

17. The non-transitory machine readable medium of claim 16, wherein the instructions that when executed cause the at least one processor to predict the image quality difference comprise instructions that when executed cause the at least one processor to:
process, using a first transformer of the Siamese transformer network, the specified image based on shared parameters;
process, using a second transformer of the Siamese transformer network, the reference image based on the shared parameters;
concatenate image representations of the specified image and the reference image; and
predict the image quality difference between the specified image and the reference image based on the image representations.

18. The non-transitory machine readable medium of claim 16, wherein the Siamese transformer network is trained by:
selecting pairs of labeled images from a labeled image dataset; and
predicting an image quality difference between the labeled images in each pair of labeled images.

19. The non-transitory machine readable medium of claim 18, wherein the Siamese transformer network is trained further by:
obtaining an unlabeled target image from an unlabeled image dataset;
generating multiple initial pseudo-labels for the unlabeled target image based on the labeled images from the labeled image dataset;
ensembling the multiple initial pseudo-labels to generate a final pseudo-label; and
unfreezing the parameters of the Siamese transformer network;
wherein the Siamese transformer network is in a prediction mode when the multiple initial pseudo-labels and the final pseudo-label are generated.

20. The non-transitory machine readable medium of claim 19, wherein the Siamese transformer network is trained further by:
associating the unlabeled target image with a labeled image from the labeled image dataset; and
predicting an image quality difference between the unlabeled target image and the associated labeled image using the final pseudo-label as a ground truth for the unlabeled target image.
